(19) United States
(12) Patent Application Publication
(10) Pub. No.: US 2016/0342202 A1
(43) Pub. Date: Nov. 24, 2016

(54) VIRTUAL REALITY APPARATUS, FEEDBACK APPARATUS, AND SYSTEM AND METHOD FOR PROVIDING REALISTIC SERVICE

(71) Applicant: SAMSUNG ELECTRONICS CO., LTD., Suwon-si (KR)

(72) Inventors: Jae Min KANG, Seoul (KR); Yong Joo KWON, Yongin-si (KR); Sun Kwon KIM, Suwon-si (KR)

(73) Assignee: SAMSUNG ELECTRONICS CO., LTD., Suwon-si (KR)

(21) Appl. No.: 15/079,288

(22) Filed: Mar. 24, 2016

(30) Foreign Application Priority Data
May 18, 2015 (KR) 10-2015-0069025

(51) Int. Cl. G06F 3/01; G06K 9/00

(52) U.S. Cl. CPC G06F 3/011; G06K 9/00718

(57) ABSTRACT

A virtual reality apparatus, a feedback apparatus, and a system and method for providing a realistic service. The virtual reality apparatus for providing a realistic service in association with at least one feedback apparatus includes: a video analyzer configured to analyze a video being played; a video feedback information generator configured to generate realistic feedback information based on the analyzing by the video analyzer; and a feedback information transmitter configured to transmit the generated realistic feedback information to the at least one feedback apparatus.

### CROSS-REFERENCE TO RELATED APPLICATION

This application claims priority from Korean Patent Application No. 10-2015-0069025, filed on May 18, 2015 in the Korean Intellectual Property Office, the entire disclosure of which is incorporated herein by reference for all purposes.

### BACKGROUND

1. Field

The following description relates to a technology of providing a realistic service and, more particularly, to a system and method for providing a realistic service.

2. Description of the Related Art

Due to demands for a simulator in which a user can experience three dimensional (3D) virtual reality as if he is in the real world, virtual reality devices have been increasingly developed. The virtual reality devices can be used in electronic environments, such as a virtual reality game and a 3D game, to provide the user with a sense of reality.

In addition, the virtual reality devices secure as wide a viewing angle as possible, so that the virtual reality devices can provide a more vivid sense of reality as compared to an existing display device. However, since a virtual reality device provides only video and sound, the virtual reality device has limitations in providing vivacity and liveliness that the user may experience in the real world.

### SUMMARY

According to an aspect of an exemplary embodiment, there is provided a virtual reality apparatus for providing a realistic service in association with at least one feedback apparatus, the virtual reality apparatus including: a video analyzer configured to analyze a video being played; a video feedback information generator configured to generate realistic feedback information based on a result of the analyzing by the video analyzer; and a feedback information transmitter configured to transmit the generated realistic feedback information to the at least one feedback apparatus.

The video analyzer may be configured to analyze, in real time, the video being played.

The video analyzer may be configured to identify and classify an object in the video being played and to analyze an activity or a status of the identified object.

The realistic feedback information may include at least one of: a type of realistic feedback to be provided through the at least one feedback apparatus; a start time for providing the realistic feedback: an end time for providing the realistic feedback; and an intensity of the realistic feedback.

The at least one feedback apparatus may include an olfactory feedback apparatus and a tactile feedback apparatus.

The virtual reality apparatus may further include a video player configured to play the video, which is received by the virtual reality apparatus, in virtual reality.

According to an aspect of another exemplary embodiment, there is provided a method for providing a realistic service in association with at least one feedback apparatus, the method including: analyzing a video being played; generating realistic feedback information based on a result of the analyzing; and transmitting the generated realistic feedback information to the at least one feedback apparatus.

The analyzing may include analyzing, in real time, the video being played.

The analyzing may include identifying and classifying an object in the video being played and analyzing an activity or a status of the identified object.

The realistic feedback information may include at least one of: a type of realistic feedback to be provided through the at least one feedback apparatus; a start time for providing the realistic feedback; an end time for providing the realistic feedback; and an intensity of the realistic feedback.

The at least one feedback apparatus may include an olfactory feedback apparatus and a tactile feedback apparatus.

The method may further include playing the video, which is received by the virtual reality apparatus, in virtual reality.

According to an aspect of another exemplary embodiment, there is provided a system for providing a realistic service, the system including: a virtual reality apparatus configured to analyze a video being played, to generate realistic feedback information based on a result of the analyzing, and to transmit the realistic feedback information to a feedback apparatus; and the feedback apparatus configured to receive the transmitted realistic feedback information from the virtual reality apparatus, and to provide realistic feedback based on the received realistic feedback information.

The virtual reality apparatus may be configured to analyze, in real time, the video being played.

The virtual reality apparatus may be configured to identify and classify an object in the video being played and to analyze an activity or a status of the identified object.

The realistic feedback information may include at least one of: a type of realistic feedback to be provided through the feedback apparatus; a start time for providing the realistic feedback; an end time for providing the realistic feedback; and an intensity of the realistic feedback.

The feedback apparatus may include at least one of an olfactory feedback apparatus and a tactile feedback apparatus.

The virtual reality apparatus may play the video, which is received by the virtual reality apparatus, in virtual reality.

According to an aspect of another exemplary embodiment, there is provided a method of providing realistic feedback for a virtual reality service, the method including: receiving, by a feedback apparatus and from a virtual reality apparatus, realistic feedback information corresponding to a video being played by the virtual reality apparatus; generating, based on the received realistic feedback information, a realistic feedback driving signal; and providing, by the feedback apparatus, the realistic feedback to a user of the virtual reality apparatus.

The received realistic feedback information may include at least one of: a type of realistic feedback to be provided through the feedback apparatus; a start time for providing the realistic feedback; an end time for providing the realistic feedback; and an intensity of the realistic feedback.

The feedback apparatus may include at least one of an olfactory feedback apparatus and a tactile feedback apparatus.

According to an aspect of another exemplary embodiment, there is provided a non-transitory computer readable recording medium having recorded thereon a program executable by a computer for performing the method.

Other features and aspects may be apparent from the following detailed description, the drawings, and the claims.

### BRIEF DESCRIPTION OF THE DRAWINGS

The above and/or other aspects will become more apparent by describing in detail exemplary embodiments with reference to the attached drawings in which:

FIG. 1 is a block diagram illustrating an example of a system for providing a realistic service, according to an exemplary embodiment;

FIG. 2 is a block diagram illustrating an example of a virtual reality apparatus shown in FIG. 1, according to an exemplary embodiment;

FIG. 3 is a block diagram illustrating an example of a feedback apparatus shown in FIG. 1, according to an exemplary embodiment;

FIG. 4 is a diagram illustrating an example in which the system shown in FIG. 1 is applied, according to an exemplary embodiment.

FIG. 5 is a flowchart illustrating an example of a method for providing a realistic service, according to an exemplary embodiment.

### DETAILED DESCRIPTION

Throughout the drawings and the detailed description, unless otherwise described, the same drawing reference numerals will be understood to refer to the same elements, features, and structures. The relative size and depiction of these elements may be exaggerated for clarity, illustration, and convenience.

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Hereinafter, expressions such as “at least one of,” when preceding a list of elements, modify the entire list of elements and do not modify the individual elements of the list.

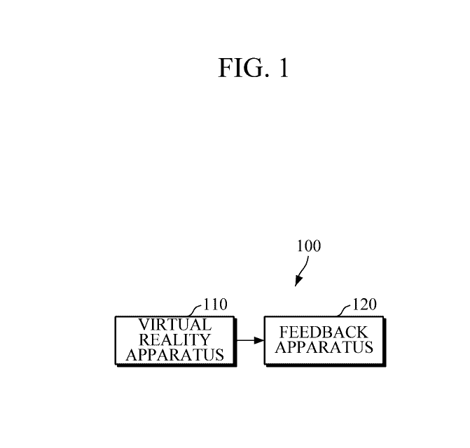

FIG. 1 is a block diagram illustrating an example of a system 100 for providing a realistic service, according to an exemplary embodiment.

Referring to FIG. 1, a system 100 for providing a realistic service includes a virtual reality apparatus 110 and a feedback apparatus 120. Although there is only one feedback apparatus 120 illustrated in the example of FIG. 1, it is understood that one or more other exemplary embodiments are not limited thereto. For example, there may be two or more feedback apparatuses according to performance and purpose of the system of another exemplary embodiment.

The virtual reality apparatus 110 may play a received video in virtual reality (VR).

In response to receipt of video and sound, the virtual reality apparatus 110 may display realistic video and output realistic sound. The realistic video and the realistic sound makes a user and/or audience feel as if in a virtual realistic location, instead of a location in the real word. For example, if video about a basketball game being played on a basketball court is received, the virtual reality apparatus 110 may output realistic video of the basketball court and realistic sound of the basketball game. In this case, a user and/or audience may feel as if currently playing the basketball game on the basketball court, as opposed to being at home.

The received video and sound may be video and sound that were recorded in the past. The virtual reality apparatus 110 may use the previously recorded video and sound to make a user to feel as if the user exists in a space or place of the past.

The virtual reality apparatus 110 may analyze, in real time, a video being played, generate, based on a result of the analysis, feedback (hereinafter, referred to as realistic feedback) information (hereinafter, referred to as realistic feedback information) for providing a realistic service, and transmit the realistic feedback information to the feedback apparatus 120, The realistic feedback may indicate various types of stimulation (e.g., sight, sound, touch, taste, smell, etc.) that gives a user a sense of a real experience. The realistic feedback information may include various types of information for providing realistic feedback through the feedback apparatus 120 including, by way of example, at least one of a type of the realistic feedback to be provided, the start time and the end time for providing the realistic feedback, intensity of the realistic feedback, etc. However, it is understood that one or more other exemplary embodiments are not limited thereto, and more, different, or less information may be included in the realistic feedback information. For example, according to another exemplary embodiment, the realistic feedback information may include a start time and a duration for providing the realistic information, without providing the end time.

The feedback apparatus 120 may receive realistic feedback information from the virtual reality apparatus 110, and, in accordance with the received realistic feedback information, provide realistic feedback (e.g., tactile feedback and olfactory feedback) in sync with a video being played.

The feedback apparatus 120 may include a wearable feedback apparatus (e.g., glove type, cloth type, necklace type, watch type, etc.), a riding-type feedback apparatus (e.g., chair type), and a stationary feedback apparatus. In addition, according to a type of a realistic feedback to be provided, the feedback apparatus 120 may include an olfactory feedback apparatus (i.e., a feedback apparatus that generates scent or smell), and a tactile feedback apparatus (i.e., a feedback apparatus that generates mechanic stimulation, such as vibration or pressure, a feedback apparatus that generates thermal stimulation, a feedback apparatus that generates wind, etc.).

For example, in the case where the feedback apparatus 120 is an olfactory-feedback apparatus, the feedback apparatus 120 may generate specific scent or smell in accordance with realistic feedback information received from the virtual reality apparatus 110. In another example, in the case where the feedback apparatus 120 is a tactile feedback apparatus, the feedback apparatus 120 my generate pressure, vibration, wind, or heat of a specific form in accordance with realistic feedback information received from the virtual reality apparatus 110. It is understood that the feedback apparatus 120 may be provided in a same device or housing as the virtual reality apparatus 110, or may be external and connected to the virtual reality apparatus. Additionally, it is understood that in one or more exemplary embodiments, plural feedback apparatuses may be provided.

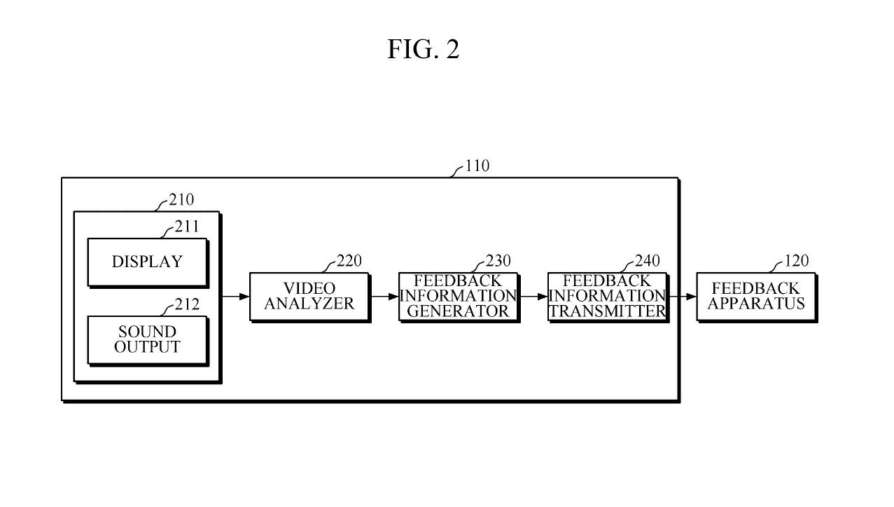

Hereinafter, the virtual reality apparatus 110 shown in FIG. 1 is described in detail with reference to FIG. 2.

FIG. 2 is a block diagram illustrating an example of a virtual reality apparatus 110 shown in FIG. 1, according to an exemplary embodiment. Referring to FIG. 2, the virtual reality apparatus 110 includes a video player 210, a video analyzer 220, a feedback information generator 230, and a feedback information transmitter 240.

The video player 210 may play a received video in virtual reality (VR). For example, in response to receipt of video and sound, the video player 210 may display realistic video and output realistic sound.

To this end, the video player 210 may include a display 211 and a sound output 212.

The display 211 may display received video in virtual reality. For example, the display 211 may be a glass-type apparatus (e.g., a Head Mounted Display (HMD)).

The sound output 212 may output received sound. For example, the sound output 212 may convert received sound into realistic sound through various signal processing procedures and output the realistic sound.

The video analyzer 220 may analyze, in real time, a video that is being played in the video player 210. For example, by analyzing a video being played, the video analyzer 220 may identify and classify an object in the video being played and analyze an activity and/or a status of the object. The object indicates a constituent element composing the video, in addition to the background, and having features that form a shape.

The feedback information generator 230 may generate realistic feedback information based on a result of the analysis. The realistic feedback information may include various types of information for providing realistic feedback through the feedback apparatus 120 including, for example, at least one of a type of the realistic feedback, the start time and the end time for providing the realistic feedback, and intensity of the realistic feedback.

For example, in the case where the feedback apparatus 120 is a glove-type/tactile feedback apparatus and a result of video analysis shows that a person grabs a baseball with a glove, the feedback information generator 230 may generate realistic feedback information including information of “providing vibration or pressure of specific intensity (a type and intensity of realistic feedback to be provided) through the feedback apparatus 120 for a specific time period (between the start time and the end time for providing feedback) starting from a point in time when the baseball is thrown into the glove.”

The feedback information transmitter 240 may transmit realistic feedback information generated by the feedback information generator 230 to the feedback apparatus 120.

The feedback information transmitter 240 may transmit the realistic feedback information to the feedback apparatus 120 over a wired/wireless network, which includes a wireless Internet, a wireless Intranet, a wireless telephony network, a Local Area Network (LAN), a Wi-Fi network, a Wi-Fi Direct network, a 3G network, a 4G Long Term Evolution (LTE) network, a Bluetooth network, an Infrared Data Association (IrDA) network, a Radio Frequency Identification (RFID) network, an Ultra WideBand (UWB) network, a Zigbee network, a Near Field Communication (NFC) network, and the like. To this end, the feedback information transmitter 240 may include a mobile communication module, a wireless Internet module, a wired Internet module, a Bluetooth module, an NFC module, and the like, although it is understood that one or more other exemplary embodiments are not limited thereto.

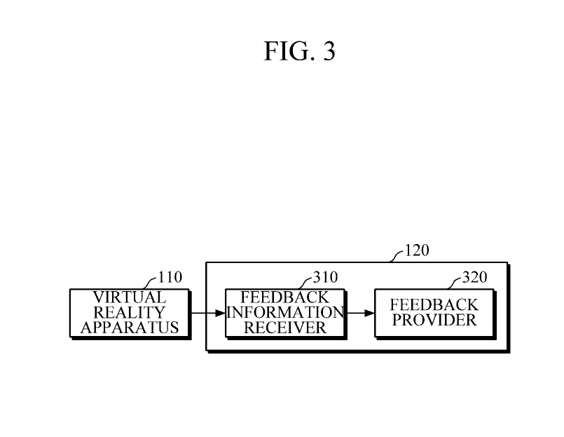

Hereinafter, the feedback apparatus 120 shown in FIG. 1 is described in detail with reference to FIG. 3.

FIG. 3 is a block diagram illustrating an example of a feedback apparatus 120 shown in FIG. 1, according to an exemplary embodiment. Referring to FIG. 3, the feedback apparatus 120 includes a feedback information receiver 310 and a feedback provider 320.

The feedback information receiver 310 may receive realistic feedback information from the virtual reality apparatus 110. The realistic feedback information may include various types of information for providing realistic feedback through the feedback apparatus 120 including, for example, at least one of a type of the realistic feedback, the start time and the end time for providing the realistic feedback, and intensity of the realistic feedback.

The feedback information receiver 310 may receive the realistic feedback information from the virtual reality apparatus 110 over a wired/wireless network, which includes a wireless Internet, a wireless Intranet, a wireless telephony network, a Local Area Network (LAN), a Wi-Fi network, a Wi-Fi Direct network, a 3G network, a 4G Long Term Evolution (LTE) network, a Bluetooth network, an Infrared Data Association (IrDA) network, a Radio Frequency Identification (RFID) network, an Ultra WideBand (UWB) network, a Zigbee network, a Near Field Communication (NFC) network, and the like. To this end, the feedback information receiver 310 may include a mobile communication module, a wireless Internet module, a wired Internet module, a Bluetooth module, an NFC module, and the like, although it is understood that one or more other exemplary embodiments are not limited thereto.

The feedback provider 320 provides a user with corresponding realistic feedback based on the received realistic feedback information. For example, the feedback provider 320 may generate a feedback driving signal based on received realistic feedback information, and, in accordance with the generated feedback driving signal, provide realistic feedback via the feedback apparatus 120, such as olfactory feedback (e.g., smell, scent, etc.) and tactile feedback (e.g., vibration, pressure, heat, wind, etc.), in sync with video that is being played in the virtual reality apparatus 110.

The feedback apparatus 120 may include a wearable feedback apparatus (e.g., glove type, cloth type, necklace type, watch type, etc.), a riding-type feedback apparatus (e.g., chair type), and a stationary feedback apparatus. In addition, according to a type of a realistic feedback to be provided, the feedback apparatus 120 may include an olfactory feedback apparatus (i.e., a feedback apparatus that generates scent or smell), and a tactile feedback apparatus (i.e., a feedback apparatus that generates mechanic stimulation, such as vibration or pressure, a feedback apparatus that generates thermal stimulation, a feedback apparatus that generates wind, etc.).

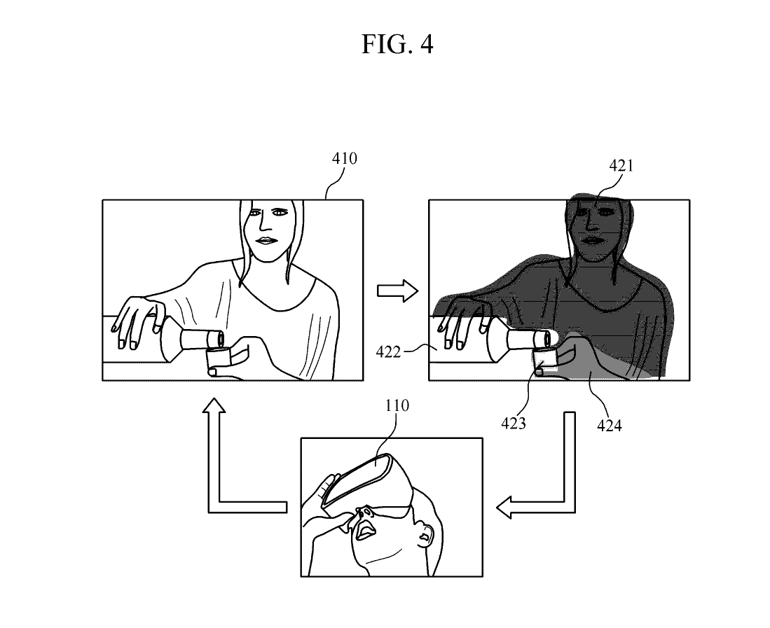

FIG. 4 is a diagram illustrating an example in which a system 100 shown in FIG. 1 is applied. In this example, it is assumed that the virtual reality apparatus 110 provides a realistic service in association with a first feedback apparatus and a second feedback apparatus, wherein the first feedback apparatus is a stationary/olfactory feedback apparatus that generates scent or smell, and the second feedback apparatus is a glove-type/tactile feedback apparatus that generates mechanic stimulation, such as vibration or pressure.

Referring to FIG. 4, by analyzing, in real time, a video 410 that is being played, the virtual reality apparatus 110 detects a person 421, a liquor bottle 422, a glass 423, and a hand 424, and analyzes an activity and/or a status of each of these recognized objects, i.e., the person 421, the liquor bottle 422, the glass 423, and the hand 424. In this case, the hand 424 may be a user's hand that is displayed in virtual reality.

If a result of video analysis shows that the person 421 tips the liquor bottle 422 to fill up the glass 423 grabbed by the hand 424, the virtual reality apparatus 110 generates first feedback information and second feedback information. In this example, the first feedback information is information to provide scent or smell corresponding to a smell of liquor through the first feedback apparatus for a predetermined time period, and the second feedback information is information to provide vibration or pressure corresponding to shaking of the glass 423 through the second feedback apparatus for a specific time period (e.g., a predetermined time period, a user-set time period, a default time period, a content provider-defined intensity, etc.).

The virtual reality apparatus 110 transmits the first realistic feedback information to the first feedback apparatus and the second realistic feedback information to the second feedback apparatus.

The first feedback apparatus receives the first realistic feedback information and, based on the first realistic feedback information, provides scent or smell corresponding to the smell of liquor in sync with the video 410 for the specific time period. The second feedback apparatus receives the second realistic feedback information and, based on the second realistic feedback information, provides vibration or pressure corresponding to the shaking of the glass 423 in sync with the video 410 for the specific time period.

By doing so, the system 100 is enabled to provide various types of feedback (e.g., olfactory feedback, tactile feedback, etc.) with realistic video and realistic sound, thereby providing a realistic service with vivacity and liveliness.

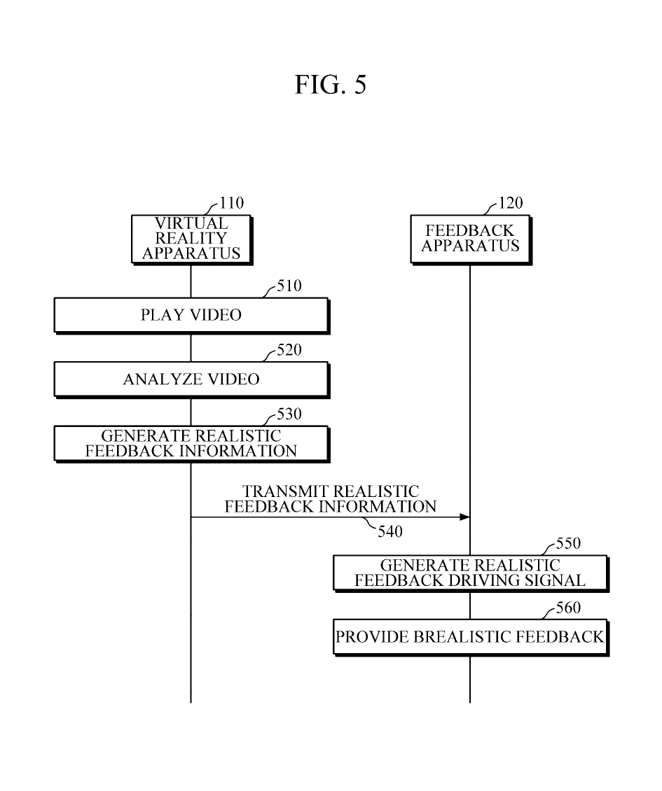

FIG. 5 is a flowchart illustrating an example of a method for providing a realistic service, according to an exemplary embodiment. FIG. 5 is described in conjunction with FIG. 1.

Referring to FIG. 5, the virtual reality apparatus 110 plays received video in virtual reality in operation 510. For example, in response to received video and sound, the virtual reality apparatus 110 may display a realistic video and output realistic sound.

The virtual reality apparatus 110 analyzes, in real time, the video being played in operation 520. For example, by analyzing the video being played, the virtual reality apparatus 110 may identify and classify an object in the video being played and analyze an activity and/or a status of the object. The object is a constituent element composing the video, in addition to the background, and having features that form a shape.

Based on a result of the analysis performed in operation 520, the virtual reality-apparatus 110 generates realistic feedback information in operation 530. The realistic feedback information may include various types of information for providing realistic feedback through the feedback apparatus 120 including, by way of example, at least one of a type of the realistic feedback, the start time and the end time for providing the realistic feedback, and intensity of the realistic feedback.

For example, in the case where the feedback apparatus 120 is a glove-type/tactile feedback apparatus and a result of the analysis shows that a person grabs a baseball with a glove, the virtual reality apparatus 110 may generate realistic feedback information including information of “providing vibration or pressure of specific intensity through the feedback apparatus 120 for a specific time period starting from a point in time when the baseball is thrown into the glove.”

The virtual reality apparatus 110 transmits the generated realistic feedback information to the feedback apparatus 120 in operation 540. The virtual reality apparatus 110 may transmit the realistic feedback information to the feedback apparatus 120 over a wired/wireless network, which includes a wireless Internet, a wireless Intranet, a wireless telephony network, a Local Area Network (LAN), a Wi-Fi network, a Wi-Fi Direct network, a 3G network, a 4G Long Term Evolution (LTE) network, a Bluetooth network, an Infrared Data Association (IrDA) network, a Radio Frequency Identification (RFID) network, an Ultra WideBand (UWB) network, a Zigbee network, a Near Field Communication (NFC) network, and the like.

The feedback apparatus 120 receives the realistic feedback information from the virtual reality apparatus 110, and generates a feedback driving signal based on the received realistic feedback information in operation 550. In accordance with the feedback driving signal, the feedback apparatus 120 provides realistic feedback in sync with the video being played in the virtual reality apparatus 110 in operation 560.

For example, in a case where the feedback apparatus 120 is a glove-type/tactile feedback apparatus that receives, from the virtual reality apparatus 110, realistic feedback information for providing vibration or pressure of specific intensity (e.g., a predetermined intensity, a default intensity, a user-defined intensity, a content provider-defined intensity, etc.) for a specific time period starting from a point in time when a baseball is thrown into a glove. In this case, the feedback apparatus 120 generates a feedback driving signal based on the received realistic feedback information and, in accordance with the feedback driving signal, provides a user with vibration or pressure of the specific intensity for the specific time period starting from a point in time when a baseball is thrown into a glove.

The methods and/or operations described above may be recorded, stored, or fixed in one or more computer-readable storage media that includes program instructions to be implemented by a computer to cause at least one processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A virtual reality apparatus for providing a realistic service in association with at least one feedback apparatus, the virtual reality apparatus comprising:
a video analyzer configured to analyze a video being played;
a video feedback information generator configured to generate realistic feedback information based on the analyzing by the video analyzer; and
a feedback information transmitter configured to transmit the generated realistic feedback information to the at least one feedback apparatus.

2. The virtual reality apparatus of claim 1, wherein the video analyzer is configured to analyze, in real time, the video being played.

3. The virtual reality apparatus of claim 1, wherein the video analyzer is configured to identify and classify an object in the video being played and to analyze an activity or a status of the identified object.

4. The virtual reality apparatus of claim 1, wherein the realistic feedback information comprises at least one of:
a type of realistic feedback to be provided through the at least one feedback apparatus;
a start time for providing the realistic feedback;
an end time for providing the realistic feedback; and
an intensity of the realistic feedback.

5. The virtual reality apparatus of claim 1, wherein the at least one feedback apparatus comprises an olfactory feedback apparatus and a tactile feedback apparatus.

6. The virtual reality apparatus of claim 1, further comprising a video player configured to play the video, which is received by the virtual reality apparatus, in virtual reality.

7. A method for providing a realistic service in association with at least one feedback apparatus, the method comprising:
analyzing a video being played;
generating realistic feedback information based on the analyzing; and
transmitting the generated realistic feedback information to the at least one feedback apparatus.

8. The method of claim 1, wherein the analyzing comprises analyzing, in real time, the video being played.

9. The method of claim 7, wherein the analyzing comprises identifying and classifying an object in the video being played and analyzing an activity or a status of the identified object.

10. The method of claim 7, wherein the realistic feedback information comprises at least one of:
a type of realistic feedback to be provided through the at least one feedback apparatus;
a start time for providing the realistic feedback;
an end time for providing the realistic feedback; and
an intensity of the realistic feedback.

11. The method of claim 7, wherein the at least one feedback apparatus comprises an olfactory feedback apparatus and a tactile feedback apparatus.

12. The method of claim 1, further comprising playing the video, which is received by the virtual reality apparatus, in virtual reality.

13. A system for providing a realistic service, the system comprising:
a virtual reality apparatus configured to analyze a video being played, to generate realistic feedback information based on the analyzing, and to transmit the generated realistic feedback information to a feedback apparatus; and
the feedback apparatus configured to receive the transmitted realistic feedback information from the virtual reality apparatus, and to provide realistic feedback based on the received realistic feedback information.

14. The system of claim 13, wherein the virtual reality apparatus is configured to analyze, in real time, the video being played.

15. The system of claim 13, wherein the virtual reality apparatus is configured to classify and identify an object in the video being played and to analyze an activity or a status of the identified object.

16. The system of claim 13, wherein the realistic feedback information comprises at least one of:
a type of realistic feedback to be provided through the feedback apparatus;
a start time for providing the realistic feedback;
an end time for providing the realistic feedback; and
an intensity of the realistic feedback.

17. The system of claim 13, wherein the feedback apparatus comprises at least one of an olfactory feedback apparatus and a tactile feedback apparatus.

18. The system of claim 13, wherein the virtual reality apparatus plays the video, which is received by the virtual reality apparatus, in virtual reality.

19. A non-transitory computer readable recording medium having recorded thereon a program executable by a computer for performing the method of claim 7.
